(19) United States
(12) Patent Application Publication
(10) Pub. No.: US 2022/0338440 A1
(43) Pub. Date: Oct. 27, 2022

(54) ANIMAL FEEDING BUCKET

(71) Applicants: Leslie P. Duke, Lindale, GA (US); Savannah G. Marion, Lindale, GA (US)

(72) Inventors: Leslie P. Duke, Lindale, GA (US); Savannah G. Marion, Lindale, GA (US)

(21) Appl. No.: 17/236,321

(22) Filed: Apr. 21, 2021

(51) Int. Cl. A01K 5/01

(52) U.S. Cl. CPC A01K 5/0107

(57) ABSTRACT

An animal feeding bucket an animal feeding bucket includes a container, a locking system, and a base plate. The container has a top edge, a bottom, and sidewalls. The base plate includes spike holes therethrough. The base plate also includes mounting spikes extending through the spike holes. The locking system includes a first locking member coupled to the base plate and a second locking member coupled to the container bottom. The first locking member has four inverted L-shaped locking flanges having vertical walls and an inwardly extending top walls. The locking flanges define lock recesses. The second locking member has four radially and outwardly extending locking tabs. Each locking tab is configured to be received within a lock recess of one locking flange to interlock the locking tab with the locking flange.

### CROSS REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present inventive concept relates to the field of an animal feeders. More particularly, the invention relates to a portable animal feeding bucket.

### Technology in the Field of the Invention

The owner of large animals, such as horses, cattle, goats or sheep, must feed their animals on a daily basis. These animals typically eat gain, or the like, that is delivered to the feeding site in buckets. These buckets of feed, or water, may vary in size and shape. The bucket may be simply placed upon the ground so that the animal may feed from the open top of the bucket.

A larger problem related to the use of feeding buckets is that the animal or animals may tip over the bucket during the feeding process, the chances of which increase when several animals are eating from the same feeding bucket. Also, the animal may accidently step on a bucket, causing it to tip over and spread the feed or water upon the ground.

Accordingly, a need exists for an animal feeder that may maintain a bucket of feed or water upright while allowing unencumbered access for the animal. It is to the provision of such therefore that the present invention is primarily directed.

### BRIEF SUMMARY OF THE INVENTION

An animal feeding bucket comprises a container for holding a volume of animal feed or water, a base plate, and a lock releasably securing the container to the base plate.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an animal feeding bucket embodying principles of the invention in a preferred form.

FIG. 2 is an exploded, perspective view of the animal feeding bucket of FIG. 1.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is a shown an animal feeding bucket 10 in a preferred form of the present invention. The animal feeding bucket 10 includes a main bucket, pale, or container 12, a coupler or locking system 14, and a base plate or platform 16.

The container 12 has a top edge 18, a bottom or floor 20, and sidewalls 22 extending between the bottom 20 and top edge 18. A pivoting carrying handle 24 may be mounted to the sidewalls 22 adjacent the top edge 18. The container 12 is specifically configured to contain animal feed, water, or other substances, herein referred collectively as animal feed F.

The base plate 16 is generally circular with a diameter equal to or greater than the diameter of the container 12 at the top edge 18. The base plate 16 includes a plurality of spike holes 28 extending therethrough from a top surface 30. The base plate 16 also includes a plurality of mounting spikes 32. Each mounting spike has an elongated shaft 34 and a head 36 at one end of the shaft 34. The elongated shaft 34 is configured to pass through spike hole 28, while the head 36 is configured to be larger than the spike hole 28 so that it does not pass through the spike hole 28, i.e., the head 36 abuts the top surface of the base plate 16.

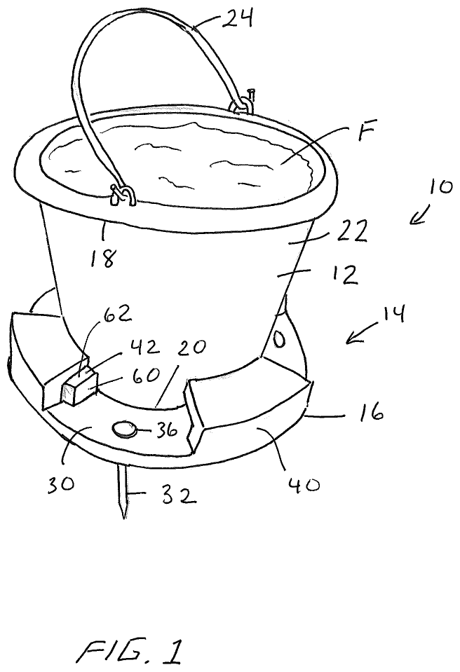

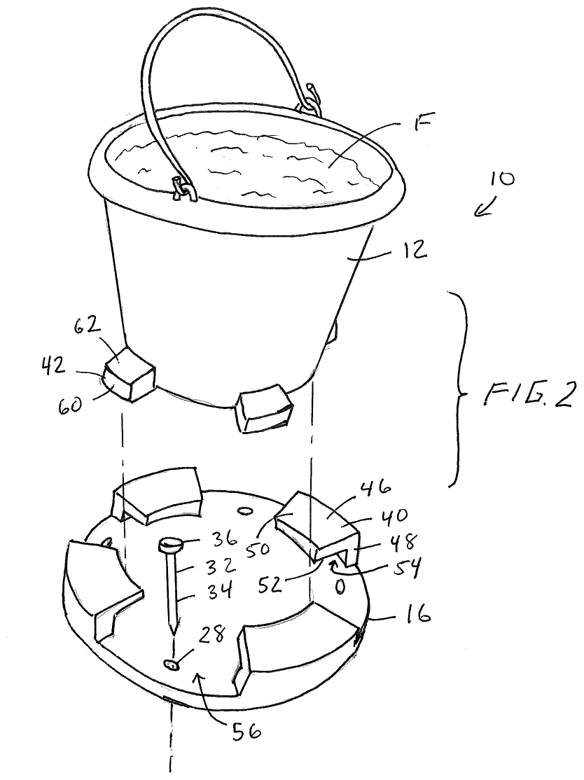

The locking system 14 includes a first locking member 40 coupled to the top surface 30 of the base plate 16 and a second locking member 42 coupled to the bottom 20 of the container 12. The first locking member 40 is configured to mate or mesh with the second locking member 42 for movement between a locked position, shown in FIG. 1, and an unlocked position, shown in FIG. 2.

The first locking member 40 has four inverted L-shaped locking catches or flanges 46. Each locking flange 46 has an upright or vertical wall 48 and an inwardly extending top wall 50. The bottom surface 52 of each top wall 50 is set at a declining angle or slope in a clockwise direction. The locking flanges 46 in combination with the base plate 16 define lock recesses 54 below the top walls 50. An entrance space 56 is positioned between each adjacent pair of locking flanges 46.

The second locking member 42 has four radially and outwardly extending locking ears, flanges, or tabs 60. Each locking tab 60 is configured to be received within entrance space 56 and be rotated into the lock recess 54 of one locking flange 46. The top surface 62 of the locking tab 60 is set at a declining angle or slope in a clockwise direction. The slope of the top surface 62 is approximately equal to the slope of the bottom surface 58 of the top wall 50, so that the locking tabs 60 and locking flanges 46 act as a cam and cam follower of a camming system that tightens the locking flange 46 of the first locking member 40 against the locking tabs 60 of the second locking member 42 through clockwise rotation of the second locking member 42.

All components of the animal feeding bucket 10 may be made of any conventional material used to form such containers, such as metal, plastic, wood, or the like.

In use, the base plate 16 may be set upon the ground at the preferred location of feeding and the mounting spikes 32 are slid though the spike holes 28 and forced into the underlying ground until the mounting spike heads 36 abut the base plate 16. Thus, the spikes firmly mount the base plate 16 to the ground.

An amount, volume, or mass of animal feed, water, or other material F may be placed within the container 12. The container 12 is then securely locked onto the base plate 16 utilizing the locking system 14. To do so, the container 12 is lowered until the locking tabs 60 are positioned within the entrance spaces 56 between adjacent locking flanges 46. The container 12 is then rotated in the clockwise direction so that the locking tabs 60 rotatably move into the lock recesses 54 below the locking flanges 46. The container 12 is rotated until the cooperation between the sloping bottom surface 52 of the locking flanges top wall 50 and the top surface 62 of the locking tabs 60 snugly interlocks the first locking member 40 with the second locking member 42, i.e., the first locking member 40 is locked to the second locking member 42.

With the container 12 locked to the base plate 16, the container 12 resists being tipped over or moved through contact with a feeding animal by both the expanded diameter of the base plate 16 compared to the bottom of the container 12. Furthermore, the container 12 is resistant to tipping through the anchoring of the animal feeding bucket 10 through the mounting spikes 32 passing through the base plate 16 and into the underlying ground.

It should be understood that as an alternative to the removable spikes 32, the base plate 16 may include spikes that are permanently affixed to extend downwardly from the base plate 16.

It should be understood that other types of coupling or locking means may be used as an alternative to the cooperating locking tabs 60 and locking flange 46 arrangement shown in the drawings. Also, it should be understood that the positioning of the locking tabs 60 and locking flanges may be reversed, so that the locking tabs 60 are positioned on the base plate 16 and the locking flanges 46 are positioned on the container 12.

It should be understood that as an alternative to the spikes 32, the base plate 16 may include other types of fasteners, such as bolts or screws, or other types of fasteners, that may be used to mount the base plate 16 to a stationary object such as a shelf, beam, floor, or bracket.

It will be appreciated that the inventions are susceptible to modification, variation and change without departing from the spirit thereof.

1. An animal feeding bucket comprising:
an open top container for holding a volume of animal feed or water;
a base plate, and
a coupler releasably securing said container to said base plate.

2. The animal feeding bucket of claim 1 further comprising at least one mounting spike extending from said base plate.

3. The animal feeding bucket of claim 2 wherein said at least one mounting spike is releasably coupled to said base plate.

4. The animal feeding bucket of claim 3 wherein said base plate includes a spike hole and wherein said at least one mounting spike is adapted to partially extend through said spike hole.

5. The animal feeding bucket of claim 1 wherein said coupler includes a plurality of first mounting flanges coupled to said container, and a plurality of second mounting flanges coupled to said base plate, wherein said plurality of first mounting flanges interlock with said plurality of second mounting flanges.

6. The animal feeding bucket of claim 5 wherein each said first mounting flange has a sloped bottom surface, and wherein each said second mounting flange has a sloped top surface,
whereby the movement of the sloped bottom surface against the sloped top surface creates a snug fit between said first mounting flange and said second mounting flange.

7. The animal feeding bucket of claim 5 wherein said first mounting flanges are radially extending mounting tabs, and wherein said second mounting flanges include a recess adapted to receive said mounting tabs.

8. An animal feeding bucket comprising:
an animal feed bucket having a plurality of radially extending locking tabs, and
a base plate having a plurality of radially extending locking flanges, wherein each said locking flange has a lock recess to rotatably receive one said locking tab of said animal feed bucket.

9. The animal feeding bucket of claim 8 further comprising at least one mounting spike extending from said base plate.

10. The animal feeding bucket of claim 9 wherein said at least one mounting spike is releasably coupled to said base plate.

11. The animal feeding bucket of claim 10 wherein said base plate includes a spike hole and wherein said at least one mounting spike is adapted to partially extend through said spike hole.

12. The animal feeding bucket of claim 8 wherein each said locking tab has a sloped first surface, and wherein each said locking flange has a sloped second surface,
whereby the movement of the sloped first surface against the sloped second surface creates a snug fit between said locking tab and said mounting flange.

13. An animal feeding bucket comprising:
a container for holding a volume of animal feed or water;
a base plate, and
at least one mounting fastener extending downwardly from said base plate.

14. The animal feeding bucket of claim 13 further comprising a coupler for releasably coupling said container to said base plate.

15. The animal feeding bucket of claim 13 wherein said at least one mounting fastener is a spike releasably coupled to said base plate.

16. The animal feeding bucket of claim 15 wherein said base plate includes a spike hole and wherein said at least one mounting spike is adapted to partially extend through said spike hole.

17. The animal feeding bucket of claim 14 wherein said coupler includes a plurality of first mounting flanges coupled to said container, and a plurality of second mounting flanges coupled to said base plate, wherein said plurality of first mounting flanges interlock with said plurality of second mounting flanges.

18. The animal feeding bucket of claim 17 wherein each said first mounting flange has a sloped bottom surface, and wherein each said second mounting flange has a sloped top surface,
whereby the movement of the sloped bottom surface against the sloped top surface creates a snug fit between said first mounting flange and said second mounting flange.

19. The animal feeding bucket of claim 18 wherein said first mounting flanges are radially extending mounting tabs, and wherein said second mounting flanges include a recess adapted to receive said mounting tabs.
